(19) United States
(12) Patent Application Publication
(10) Pub. No.: US 2012/0116605 A1
(43) Pub. Date: May 10, 2012

(54) ELECTRONIC VEHICLE SECURITY KEY

(75) Inventors: Shafer Seymour, Bartlett, IL (US); Robert Gee, Lake Barrington, IL (US)

(73) Assignee: CONTINENTAL AUTOMOTIVE SYSTEMS, INC., Deer Park, IL (US)

(21) Appl. No.: 12/940,178

(22) Filed: Nov. 5, 2010

(51) Int. Cl. G06F 17/00; G08B 29/00

(52) U.S. Cl. 701/1; 340/5.6

(57) ABSTRACT

An electronic vehicle security key for vehicles stores vehicle data and user data in separate, protected memories that are coupled to a processor. Information in the protected memories is exchanged with a processor in a vehicle. The information in the vehicle security key instructs the processor in a vehicle whether to enable the vehicle to operate and if so, when and how the vehicle should be operated.

### BACKGROUND

The security and the usage of motor vehicles is problematic for many vehicle owners but especially vehicle fleet operators. Prior art mechanical keys are relatively easy to defeat, which makes cars and trucks equipped with them relatively easy to take. Wireless or keyless entry systems provide a somewhat better security than mechanical keys but they too can be defeated.

In addition to being relatively easy to defeat, prior art vehicle security devices provide no control over vehicle usage nor do they provide any sort of history or record of a vehicle's use and are therefore of little value to vehicle owners who wish to limit how a vehicle is used, by whom it is used, as well as when and where it is used. A vehicle security device, that provides a higher level of security, and which can limit or control who uses a vehicle, limit or control how and where it is used, and record what it has been used to do would be an improvement over the prior art.

### BRIEF DESCRIPTION OF THE DRAWINGS

FIG. 1 is a block diagram of a vehicle security system using an electronic vehicle security key;

FIG. 2 is a block diagram of an electronic vehicle security key; and

FIG. 3 is a block diagram of vehicle electronics, depicting how an electronic vehicle security key interacts with a vehicle.

### DETAILED DESCRIPTION

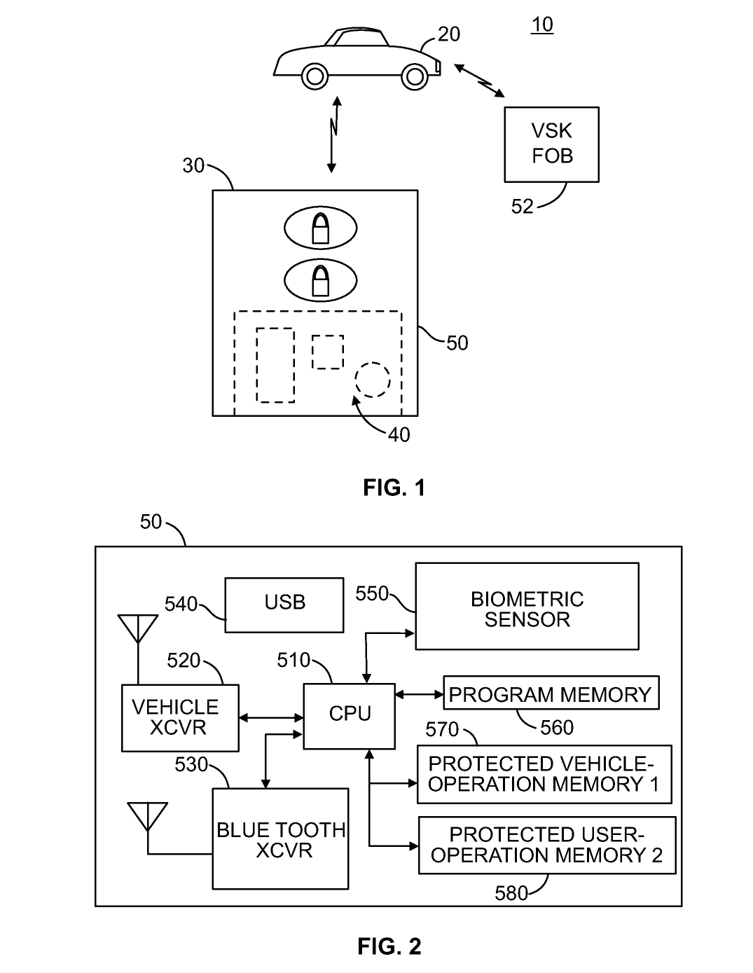

FIG. 1 depicts a vehicle security system 10. The system is comprised of an automobile or other vehicle 20, and in the embodiment shown, the vehicle 20 is configured to be used with a wireless ignition key 30. The wireless ignition key 30 is embodied as a relatively small, portable, hand-held parallelepiped-shaped housing or fob. The fob is provided with a card-slot 40 and an associated connector inside the slot, which is not shown. The slot 40 is sized, shaped and arranged to receive an electronic vehicle security key 50 (eVSK) so that the eVSK or simply, the VSK, can be operated in parallel or simultaneously with communications that take place between the electronic security key 50 and the vehicle. In an alternate embodiment, the electronic security key 50 is embodied as a separate hand-held portable fob 52 which also communicates wirelessly with the vehicle.

Wireless ignition keys, also known as keyless entry systems, are well-known in the art. In a keyless entry system, a low-power radio frequency signal is broadcast from a vehicle 20. When a wireless ignition key 30 is within range of the signal broadcast by the vehicle 20, the wireless ignition key 30 responds with a second radio frequency transmission to the vehicle 20. A “hand-shaking” takes place between the wireless ignition key 30 and the vehicle 20 to identify the ignition key 30 as corresponding to the vehicle 20. A successful registration of the wireless key 30 enables the vehicle 20 to be operated.

The electronic vehicle security key disclosed herein operates separately and independently from a wireless ignition key 30. The electronic vehicle security key 50 disclosed herein participates in its own “hand-shaking” with the vehicle 20.

FIG. 2 is a block diagram of the electronic vehicle security key 50, for brevity purposes, the block diagram also depicts the structure and operation of a standalone electronic vehicle security fob 52. As can be seen in FIG. 2, a central processing unit 510 controls operation of a vehicle communications transceiver 520, a Bluetooth transceiver 530, a universal serial bus or “USB” interface 540, and a biometric sensor 550. The functionality of the central processing unit 510 is provided by program instructions and data stored in a program memory device 560.

In a first embodiment, two protected memory locations, ranges or devices physically within the electronic vehicle security key 50, store vehicle-operation data and user data respectively. Vehicle-operation data includes information, specifications about the vehicle, maintenance records and requirements and limitations as to how a particular vehicle should be used. Vehicle-operation data also includes data that uniquely identifies one or more electronic vehicle security keys 50 that can be used with the vehicle and by which the electronic vehicle security key 50 can be identified by a vehicle 20.

Vehicle-operation data also includes but is not limited to vehicle use limitations. Vehicle use limitations include, but are not limited to a geographic range or coordinates wherein the vehicle may be used. Vehicle use information can also include geographic coordinates or locations beyond which the vehicle operation should be interrupted.

Vehicle-operation data includes information that specifies or identifies one or more individuals as authorized users, i.e., people who have permission or qualifications to operate a motor vehicle 20. Authorized user data can be embodied as numbers or strings of alpha-numeric characters but can also include biometric data such as a person's fingerprint or retinal pattern.

Vehicle-operation data also includes a record of a vehicle's use. A record or history of a vehicle's use can include a driver's habits, acceleration, braking and so forth as well as the dates, times, and locations of stops that a vehicle user made over a user-defined period of time.

In addition to storing user-operation data, the electronic vehicle security key has one or more separate memory locations, address ranges or devices wherein user data is stored. User data includes but is not limited to navigation information. Navigation information for a user can include a route that a user is to follow, destinations or locations that a user stops at or is expected to stop at, dates, times of operation, acceleration, and braking habits and fuel economy information. In instances where a vehicle is part of a for-hire fleet, user-operation data includes payment information. Payment information can include a credit card number, or an accumulation of fees and costs accruing to the fleet operator by virtue of the user's operation.

A principal difference between vehicle-operation data and user data is that user data can be changed by a user of either a vehicle or of the electronic vehicle security key. Vehicle-operation data can be changed by either a vehicle or a system administrator, an example of which would be a fleet owner or operator. The vehicle-operation data and the user-operation are stored in protected memory devices of the electronic vehicle security key 50 to prevent the data stored therein from being compromised and vehicle security lost as a result thereof. Vehicle-operation data is stored in a first protected memory device 570. User-operation data is stored in a second and different protected memory device 580.

While FIG. 2 depicts two separate memory devices 570 and 580, those of ordinary skill in the art will recognize that a single memory device can also be used instead. Different memory locations or different address ranges can be allocated or designated to be vehicle-operation data and user-data with access to the respective memory locations being restricted.

Separate memory address locations, address ranges or physical devices are considered herein as being protected because read and write access to them is restricted. Access control is implemented by program instructions, which are stored in program memory device 560 and executed by the CPU 510.

In one embodiment, the CPU 510 provides the first and second memories 570 and 580 with different levels of access-protection by encrypting the contents of the respective memories differently. The encryptions are performed according to program instructions stored in a program memory 560. When these program instructions are executed by the CPU 510, the contents of the memories are encoded differently such that decoding them requires different decryption algorithms. The access to the memories 570 and 580 can thus be controlled by controlling the decryption algorithm.

In one embodiment, a robust encryption algorithm executed by the CPU 510 encrypts the contents of the first protected memory 570 such that read and write access to the first protected memory 570 is available to only a system administrator or a particular vehicle 20 associated with the electronic vehicle security key 50. Information in the first protected memory 570 can be read and used by a controller for a particular vehicle 20 associated with the electronic vehicle security key 50. Information in the first protected memory 570 can also be read and used by controllers in other vehicles 20 that might also be associated with the electronic vehicle security key 50. Information in the first protected memory 570 can be read, written, and transmitted by controllers in other, separate devices such as personal computers operated by a system administrator. By way of example, an eVSK having a universal serial bus or “USB” interface 540 can be plugged into the USB port of a system administrator's personal computer whereby data stored on the eVSK can be uploaded to the system administrator's computer for analysis. Data can also be downloaded from the system administrator's computer into the eVSK. Data downloaded to the first protected memory determines or controls how a vehicle associated with the eVSK can be operated.

A second access-protection level embodied as a less-robust encryption, or no encryption enables read and write access to the second protected memory 580 by an authorized user of the vehicle 20, a system administrator or a particular vehicle 20 that the electronic vehicle security key 50 is to be used with.

In one embodiment, different access protection levels are provided by using different encryption schemes for information stored in the protected memory devices 570 and 580. In another embodiment, access protection can be provided by strictly limiting read and write access by the CPU 510 under program control. Stated another way, instructions stored in program memory 560 can be provided that, when executed, prohibit the CPU 510 from reading or writing to any of the address locations within the corresponding protected memories.

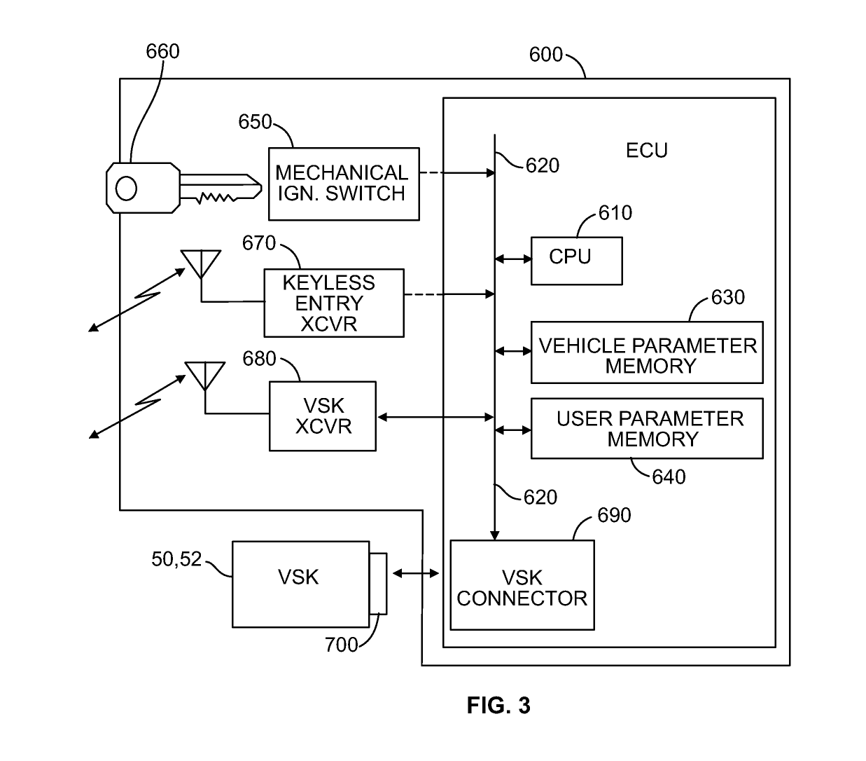

Vehicle-operation data is exchanged with a vehicle 20 via a vehicle transceiver 520 operatively coupled to the CPU 510 by a bus, well-known to those of ordinary skill in the electronics art. The vehicle transceiver 520 is comprised of a transmitter and receiver which communicate using an RF (radio frequency) communications link. A corresponding transceiver in the vehicle, and which is depicted in FIG. 3 enables the exchange of vehicle parameters between the vehicle 20 and the electronic vehicle security key 50.

User data is written into and read from the electronic vehicle security key using a different radio interface. In one embodiment, a Bluetooth transceiver 530, which is also coupled to the CPU 510 via the same bus, enables information and data to be transferred into the second protected memory 580 via the Bluetooth communications link. Historical data such as a vehicle's usage, which would be obtained from the vehicle 20 via the vehicle transceiver 520 and stored in the second protected memory 580, can be read from the electronic vehicle security key 50 via the Bluetooth transceiver 530. The Bluetooth transceiver 530 thus provides a second radio link by which an authorized vehicle user, an administrator or even a vehicle having a corresponding Bluetooth transceiver can send and receive information to and from the electronic vehicle security key 50.

In addition to exchanging user data, the Bluetooth transceiver 530 can also be used to read and write vehicle-operation data into and out of the first protected memory 570. The same protocol that would be used to exchange user data can thus be used to exchange vehicle-operation data.

In addition to a wireless interface to the electronic vehicle security key, in another embodiment also depicted in FIG. 2 a universal serial bus or “USB” interface 540 provides a pathway for information between the electronic security key 50 and a personal computer, not shown in the drawings. A personal computer thus provides a mechanism by which user data and vehicle-operation data stored in the vehicle security key can be changed. The USB port 540 in combination with the CPU 510 and appropriate program instructions stored on program memory 560 allow both vehicle-operation data to be written and read from the first protected memory as well as user-data to be written into and read from the second protected memory 580.

In another embodiment, also depicted with FIG. 2, a biometric sensor 550 is coupled to the CPU 510 via the same bus. As shown in the figure, the biometric sensor 550 is part of the electronic vehicle security key. Examples of a biometric sensor include a fingerprint reader or retinal scanner.

Using appropriate program instructions stored in program memory 560, the electronic vehicle security key 50 can limit vehicle usage to a particular individual whose biometric data is stored in one or both of the protected memories 570 and 580. By reading biometric data from the biometric sensor 550 the CPU 510 can readily determine whether or not the person whose biometric data was read by the sensor 550 is authorized to use the vehicle or determine the extent or nature of the privileges to be provided to the user whose data was read.

Biometric data read by the sensor 550 can be verified by the CPU 510 and the results of that comparison transmitted to the vehicle 20 via the vehicle transceiver 520. The electronic vehicle security key 50 thus intercepts or prevents operation of the vehicle 20 by inhibiting or authorizing the operation of the vehicle 20.

FIG. 3 is a functional block diagram of the vehicle 20 and the vehicle's electronic control unit or ECU 600. For simplicity, the ECU is depicted as having a central processing unit 610 which communicates with various peripheral devices via a bus 620 connected to the bus 620 are a vehicle parameter memory 630 and a user memory 640. Similar to the protected memories of the electronic vehicle security key 50, the vehicle parameter memory 630 stores data particular or relevant to operation of the vehicle. The user parameter memory stores information particular to the authorized users of the vehicle 20 in which the ECU 600 is fixed. Communications with the CPU 610 which would include authorizations to operate the vehicle 20 by the electronic vehicle security key 50 are provided to the CPU 610 in various ways. In one embodiment, a mechanical ignition switch 650 and which is well-known in the prior art receives a mating key 660. Operation of the switch 650 by the appropriate key 660 sends a signal to the CPU 610 via the bus 620 informing the CPU that a proper key has been provided requesting the vehicle to be operated.

In another embodiment, a keyless entry transceiver 670 exchanges signals with the keyless entry key fob or wireless ignition key 30 described above and shown in FIG. 1. Upon completion of the hand-shaking sequence, the keyless entry transceiver 670 so notifies the CPU 610. In either of the embodiments described above, operation of the vehicle 20 is inhibited unless and until authorization signals are received from the electronic vehicle security key 50 through a vehicle security key transceiver 680 which is also coupled to the bus 620 in order to communicate with the CPU 610. As described above, information sent to the vehicle 20 from the electronic vehicle security key can include both vehicle-operation data and user-data. Such data is transmitted wirelessly via a radio frequency link to the vehicle security key transceiver 680. From there it is relayed to the CPU 610, which compares the information received from the electronic vehicle security key 50 to its own records stored in either the vehicle parameter memory 630 or the user parameter memory 640. Upon a successful comparison of the information from the key 50 to the information stored in the vehicle 20, and more particularly in the ECU 600, vehicle operation is enabled as well as the recordation of information as required by program instructions on how the vehicle is to be used.

In another embodiment, the ECU 600 is provided with an electronic vehicle security key connector 690. In one embodiment, the vehicle security key connector 690 is embodied as a USB connector accessible from the vehicle dashboard. In such an embodiment, the vehicle security key 50 is provided with a mating USB connector 700. When the vehicle security key 50/52 is inserted to the vehicle security key connector 690 in the dash, information in the protected memories 570 and 580 within the electronic vehicle security key 50 can be exchanged with the vehicle 20 via the USB port 540 within the vehicle security key 50. The electronic vehicle security key 50 can thus be considered a wired, i.e. non-wireless device.

As set forth above, and as shown in FIG. 1, the electronic vehicle security key 50 depicted in block diagram form in FIG. 2 can be configured to be enclosed within a prior art wireless or keyless entry system fob. In another embodiment, the electronic vehicle security key 50 can be a separate hand-held device provided with its own power source, not shown in FIG. 2, but well-known to those of ordinary skill in the art. Typical power sources include one or more batteries, an inductive pick-up by which a battery within the key 50 could be kept charged, or the key 50 could be powered by the inductive pick-up of radio frequency energy around the device.

In as much as the electronic vehicle security key 50 can, in one embodiment, be inserted into an electronic key fob 30 or a fob holding the electronic security key 50 can be provided with a mechanical key, another embodiment of the vehicle security device includes an ignition key as both a mechanical device and a wireless device. In instances where the electronic vehicle security device 50 is inserted into a wireless or keyless entry fob 30 the ignition key functionality will be provided by its own processor. Such a device will also typically include its own memory device coupled to the corresponding processor by which the parameters exchange between the key 30 and vehicle 20 can be kept.

From the foregoing description, those of ordinary skill in the art will recognize that a method of controlling a vehicle is implemented using the structures depicted in the figures. A vehicle, such as an automobile or truck can be controlled and its usage tracked by reading vehicle-operation data from a first protected memory location or address range or device. Upon the determination or evaluation of the vehicle operation data, as a second step authorized-user operational data can also be read from other locations or devices. The information read from the memory devices that hold vehicle-operation data and user-operation data can be evaluated and transmitted to the vehicle over a wireless data link by which the operation and usage of the vehicle can be controlled according to the parameters read from the corresponding memories.

In embodiments described above, the vehicle-operation data and user-operation data are kept in separately protected memory locations, memory ranges or memory devices. Keeping such data separate, and separately protected, using different protection schemes, is intended to thwart the circumvention of the security that is intended to be provided with respect to controlling use of a vehicle and storing and retrieving data regarding how a vehicle has been used.

The foregoing description is for purposes of illustration only. The true scope of the invention is set forth in the appurtenant claims.

What is claimed is:

1. A vehicle security key comprising:
a processor;
first and second protected memories coupled to the processor, the first protected memory being configured to store vehicle-operation data, the second protected memory being configured to store user data;
wherein the first and second memories are provided corresponding access-protection levels, the first and second access-protection levels being different from each other.

2. The vehicle security key of claim 1, wherein the first and second memories are comprised of first and second pluralities of memory ranges in at least one memory device, access to the first and second memory ranges being limited by the processor.

3. The vehicle security key of claim 2, wherein the first access-protection level enables read and write access by at least one of:
a vehicle associated with the vehicle security key; and
an administrator.

4. The vehicle security key of claim 2, wherein the second access-protection level enables read and write access by at least one of:
a vehicle associated with the vehicle security key;
an administrator; and
an authorized vehicle user.

5. The vehicle security key of claim 1, further comprising a biometric sensor coupled to the processor.

6. The vehicle security key of claim 1, further comprising a power source coupled to at least one of the processor and first and second memories.

7. The vehicle security key of claim 1, wherein the vehicle security key is configured to be enclosed within an ignition key for a vehicle.

8. The vehicle security key of claim 1, wherein the vehicle security key is physically separated from an electronic ignition vehicle key.

9. The vehicle security key of claim 1, wherein the vehicle-operation data comprises at least one of:
an identifier for the vehicle security key; and
at least one of:
i) vehicle use limitation;
ii) authorized user data; and
iii) a record of vehicle use.

10. The vehicle security key of claim 1, wherein the user-operation data comprises at least one of:
user authentication information; and
at least one of:
i) payment information;
ii) navigation information; and
iii) routing information.

11. A vehicle security device comprising:
an ignition key;
a processor;
first and second protected memories coupled to the processor, the first protected memory being configured to store vehicle-operation data, the second protected memory being configured to store user data;
wherein the first and second memories are provided corresponding access-protection levels, the first and second access-protection levels being different from each other.

12. The vehicle security key of claim 11, wherein the ignition key is comprised of a third memory.

13. The vehicle security key of claim 12, wherein the third memory is coupled to the processor.

14. The vehicle security key of claim 12, wherein the first, second and third memories and the processor are co-located within a single housing.

15. The vehicle security key of claim 11, wherein the first access-protection level enables read and write access by at least one of:
a vehicle associated with the vehicle security device; and
an administrator.

16. The vehicle security key of claim 11, wherein the second access-protection level enables read and write access by at least one of:
a vehicle associated with the vehicle security device;
an administrator; and
an authorized vehicle user.

17. A method of controlling vehicle use comprising the steps of:
reading vehicle operation data from a first memory;
reading authorized user operation data from a second memory; and
sending a first signal to a vehicle, the first signal limiting the vehicle usage to be consistent with the vehicle operation data and the user operation data.

18. The method of claim 17, wherein the step of reading vehicle operation data is comprised of reading data from a first access-protected memory and wherein the step of reading authorized user operation data is comprised of reading data from a second, access-protected memory, wherein the first access-protected memory is protected using a first protection level and wherein the second access-protected memory is protected using a second protection level.

19. The method of claim 17, wherein the step of reading vehicle operation data is comprised of reading:
authentication information for a vehicle security key; and
at least one of:
i) vehicle use limitation;
ii) authorized user data; and
iii) a record of vehicle use.

20. The method of claim 17, wherein the step of reading authorized user operation data is comprised of reading:
user authentication information; and
at least one of:
i) payment information;
ii) navigation information; and
iii) routing information.
